(19) United States
(12) Patent Application Publication
(10) Pub. No.: US 2021/0084263 A1
(43) Pub. Date: Mar. 18, 2021

(54) SURVEILLANCE ASSIST DEVICE

(71) Applicant: MITSUBISHI ELECTRIC CORPORATION, Tokyo (JP)

(72) Inventors: Tomohiro HOSOKAWA, Tokyo (JP); Takeshi UEDA, Tokyo (JP); Daisuke SUZUKI, Tokyo (JP)

(73) Assignee: MITSUBISHI ELECTRIC CORPORATION, Tokyo (JP)

(21) Appl. No.: 16/961,801

(22) PCT Filed: Jan. 19, 2018
(86) PCT No.: PCT/JP2018/001610

§ 371 Date: Jul. 13, 2020

(51) Int. Cl. H04N 7/18; H04N 5/232; G06K 9/00; G06T 7/246

(52) U.S. Cl. CPC H04N 7/185; H04N 5/23299; G06T 2207/10016; G06T 7/248; G06K 9/00711

(57) ABSTRACT

A swing unit (411) performs swing control of causing a camera which photographs a stationary object to change a photographing range. A position calculation unit (413) calculates a last-time position representing a portion showing the stationary object in a last-time image obtained by the camera before the swing control, and a this-time position representing a portion showing the stationary object in a this-time image object obtained by the camera after the swing control. A verification unit (415) determines whether the this-time image is a false image based on a quantity of change in the photographing range resulting from the swing control and a quantity of change in the this-time position from the last-time position.

### TECHNICAL FIELD

The present invention relates to a technique for detecting video spoofing.

### BACKGROUND ART

In a conventional surveillance system, surveillance disturbance such as photographing disturbance and video spoofing occurs.

In photographing disturbance, a screen displaying a video of a surveillance target in a normal state is placed in front of the surveillance target, and the surveillance target is stolen.

In video spoofing, a video from a surveillance camera is replaced with an old video on a transmission line in some way, and the old video is repeatedly displayed on a surveillance monitor so that an intruder is not displayed on the surveillance monitor.

In a building or facility where a large number of surveillance cameras are installed, a large number of surveillance monitors are prepared. In this case, it is difficult to constantly keep all the surveillance monitors under surveillance, and there is a high possibility that switching from a normal video to a false video is missed. In addition, it is also difficult to notice a false video when surveillance videos are displayed on a small number of surveillance monitors by switching.

### CITATION LIST

### Patent Literature

Patent Literature 1: JP 2013-120557 A

Patent Literature 2: JP 2007-318480 A

Patent Literature 3: JP 2005-333415 A

### SUMMARY OF INVENTION

### Technical Problem

Patent Literature 1 describes, as a countermeasure against photographing disturbance, a technique of determining falsification of a video by using a plurality of images obtained by photographing a surveillance target at different angles.

However, the technique disclosed in Patent Literature 1 cannot determine video spoofing.

Patent Literature 2 describes a technique of detecting video spoofing. According to this technique, a surveillance camera is caused to perform an operation such as pan, tilt, and zoom. Then, by comparing a video estimated from the operation with the video reflected on a surveillance monitor, video spoofing is detected.

Patent Literature 3 describes a technique as follows.

A lighting apparatus is arranged near a photographing range of a surveillance camera. A surveillance system changes illuminance of the photographing range by turning on or off the lighting apparatus. The surveillance system determines a difference between videos based on a change over time of brightness or color.

However, in both of the techniques of Patent Literature 2 and Patent Literature 3, in order to detect video spoofing, it is necessary to cause a large change on an entire screen displaying the video by a signal generator provided within a surveillance range.

It is expensive, however, to prepare an environment that utilizes the signal generator, including purchase of the signal generator.

Even when a large change is caused on the entire screen displaying the video, video spoofing cannot be detected depending on the content of the false video, and security stays weak.

It is an objective of the present invention to enable detection of video spoofing.

### Solution to Problem

A surveillance assist device according to the present invention includes:

a swing unit to perform swing control of causing a camera which photographs a stationary object to change a photographing range;

a position calculation unit to calculate a last-time position representing a portion showing the stationary object in a last-time image obtained by the camera before the swing control, and a this-time position representing a portion showing the stationary object in a this-time image obtained by the camera after the swing control; and

a verification unit to determine whether the this-time image is a false image based on a quantity of change in the photographing range resulting from the swing control and a quantity of change in the this-time position from the last-time position.

### Advantageous Effects of Invention

According to the present invention, video spoofing can be detected.

### BRIEF DESCRIPTION OF DRAWINGS

FIG. 1 is a configuration diagram of a surveillance system 100 in Embodiment 1.

FIG. 2 is a diagram illustrating a surveillance system 100A in Embodiment 1.

FIG. 3 is a configuration diagram of a camera 200 in Embodiment 1.

FIG. 4 is a configuration diagram of a recorder 300 in Embodiment 1.

FIG. 5 is a configuration diagram of a surveillance assist device 400 in Embodiment 1.

FIG. 6 is a diagram illustrating a storage unit 421 in Embodiment 1.

FIG. 7 is a diagram illustrating a camera management file 431 in Embodiment 1.

FIG. 8 is a diagram illustrating a facility management file 432 in Embodiment 1.

FIG. 9 is a diagram illustrating a pattern file 434 in Embodiment 1.

FIG. 10 is a diagram illustrating swing control patterns in Embodiment 1.

FIG. 11 is a flowchart of a surveillance assist method in Embodiment 1.

FIG. 12 is a flowchart of spoofing detection processing (S200) in Embodiment 1.

FIG. 13 is a diagram illustrating representative positions in Embodiment 1.

FIG. 14 is a flowchart of encrypted communication in Embodiment 1.

FIG. 15 is a hardware configuration diagram in the embodiment.

### DESCRIPTION OF EMBODIMENTS

In the embodiment and drawings, the same elements and equivalent elements are denoted by the same reference numerals. Description of the elements denoted by the same reference numerals will be arbitrarily omitted or simplified. Arrows in the drawings mainly illustrate flows of data or flows of processing.

### Embodiment 1

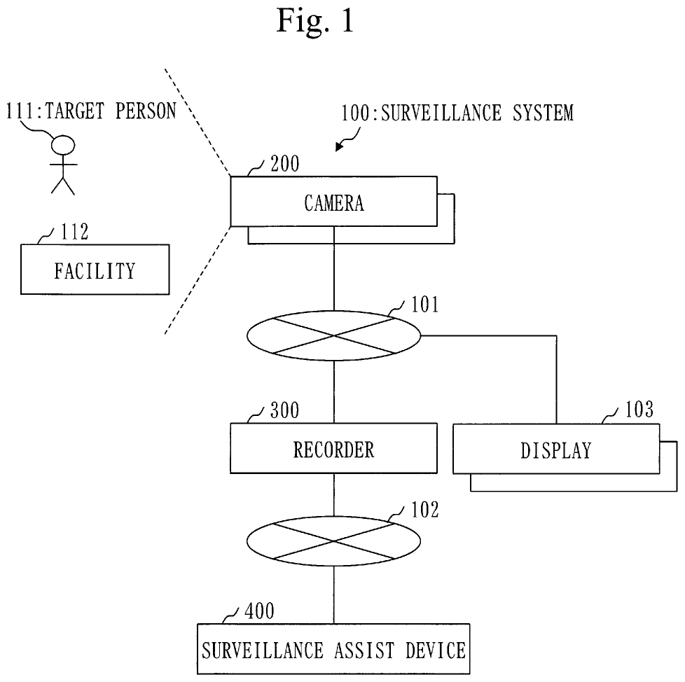

A mode of detecting video spoofing will be described with referring to FIGS. 1 to 14.

***Description of Configuration***

A configuration of a surveillance system 100 will be described with referring to FIG. 1.

The surveillance system 100 is provided with one or more cameras, one or more displays, a recorder 300, and a surveillance assist device 400.

Where the cameras are not specified, each camera will be called a camera 200.

Where the displays are not specified, each display will be called a display 103.

The clock times of the camera 200, display 103, recorder 300, and surveillance assist device 400 are synchronized.

Clock time synchronization is performed with utilizing, for example, Network Time Protocol (NTP).

The camera 200, the display 103, and the recorder 300 communicate with each other via a first network 101.

The recorder 300 and the surveillance assist device 400 communicate with each other via a second network 102.

For example, the first network 101 and the second network 102 are each a Local Area Network (LAN).

The camera 200 is set at a location to keep under surveillance.

The recorder 300, the surveillance assist device 400, and each display 103 are set at locations where monitoring is performed.

An object such as a target person 111 and facility 112 exist at a location to keep under surveillance.

The target person 111 is a person to be photographed. The target person 111 is a specific example of a mobile object.

The facility 112 is an object to be photographed. The facility 112 is a specific example of a stationary object.

Broken lines indicate a photographing range of the camera 200.

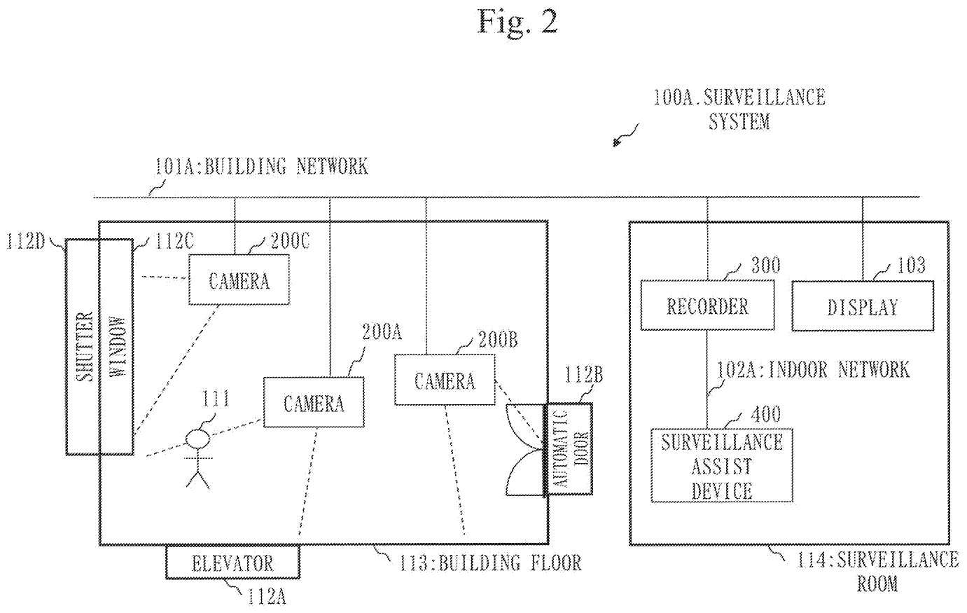

A surveillance system 100A will be described with referring to FIG. 2.

The surveillance system 100A is a specific example of the surveillance system 100.

In the surveillance system 100A, a building floor 113 is a specific example of the location to keep under surveillance, and a surveillance room 114 is a specific example of a location where surveillance is performed. The building floor 113 means a floor in a building.

A building network 101A is a specific example of the first network 101, and an indoor network 102A is a specific example of the second network 102. The building network 101A means a network provided to the building. The indoor network 102A means a network provided to the surveillance room 114.

Three cameras (200A to 200C) are set on the building floor 113.

The target person 111 exists on the building floor 113. A specific target person 111 is a user of the building or an intruder to the building.

Furthermore, facilities 112 such as an elevator 112A, an automatic door 112B, a window 112C, and a shutter 112D exist on the building floor 113.

A recorder 300, a display 103, and a surveillance assist device 400 are set in the surveillance room 114.

The three cameras (200A to 200C), the recorder 300, and the display 103 are connected to the building network 101A.

The recorder 300 and the surveillance assist device 400 are connected to the indoor network 102A.

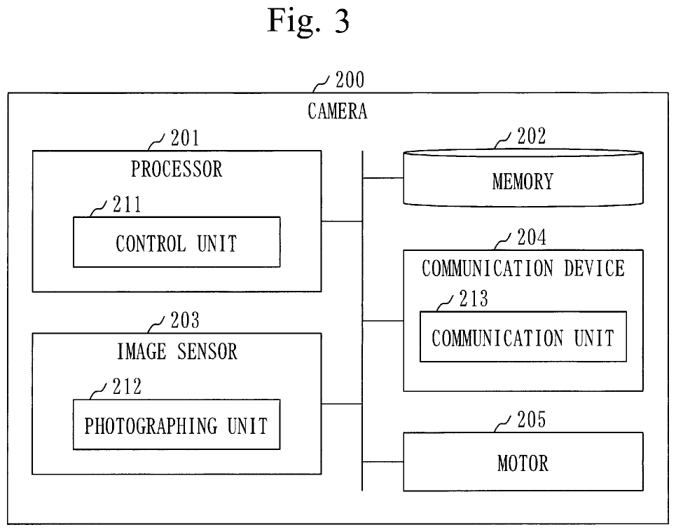

A configuration of the camera 200 will be described with referring to FIG. 3.

The camera 200 is provided with hardware devices such as a processor 201, a memory 202, an image sensor 203, a communication device 204, and a motor 205. These hardware devices are connected to each other via signal lines.

The processor 201 is an Integrated Circuit (IC) which performs computation processing, and controls the other hardware devices. The processor 201 is, for example, a Central Processing Unit (CPU), a Digital Signal Processor (DSP), or a Graphics Processing Unit (GPU).

The memory 202 is a volatile storage device. The memory 202 is also called a main storage device or a main memory. For example, the memory 202 is a Random Access Memory (RAM).

The image sensor 203 is a set of imaging devices. For example, the image sensor 203 is a CMOS image sensor or a CCD image sensor. Note that CMOS stands for Complementary Metal Oxide Semiconductor, and CCD, a Charge Coupled Device.

The communication device 204 is a receiver/transmitter. For example, the communication device 204 is a communication chip or a Network Interface Card (NIC).

The motor 205 is a pan/tilt motor. The pan motor is a motor for shifting the orientation of the camera 200 right and left. The tilt motor is a motor for shifting the orientation of the camera 200 up and down.

The processor 201 functions as a control unit 211.

The image sensor 203 functions as a photographing unit 212.

The communication device 204 functions as a communication unit 213.

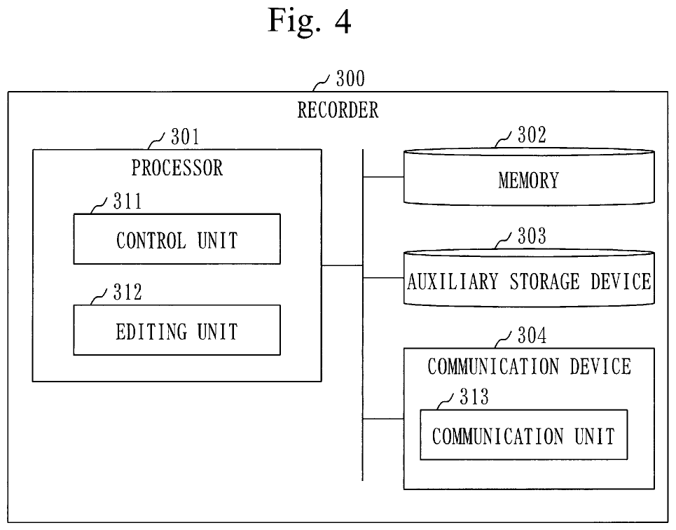

A configuration of the recorder 300 will be described with referring to FIG. 4.

The recorder 300 is provided with hardware devices such as a processor 301, a memory 302, an auxiliary storage device 303, and a communication device 304. These hardware devices are connected to each other via signal lines.

The processor 301 is an IC which performs computation processing, and controls the other hardware devices. The processor 301 is, for example, a CPU, a DSP, or a GPU.

The memory 302 is a volatile storage device. The memory 302 is also called a main storage device or a main memory. For example, the memory 302 is a RAM. Data stored in the memory 302 is saved in the auxiliary storage device 303 where necessary.

The auxiliary storage device 303 is a non-volatile storage device. For example, the auxiliary storage device 303 is a Read Only Memory (ROM), a Hard Disk Drive (HDD), or a flash memory. Data stored in the auxiliary storage device 303 is loaded to the memory 302 where necessary.

The communication device 304 is a receiver/transmitter. For example, the communication device 304 is a communication chip or an NIC.

The processor 301 functions as a control unit 311 and an editing unit 312.

The communication device 304 functions as a communication unit 313.

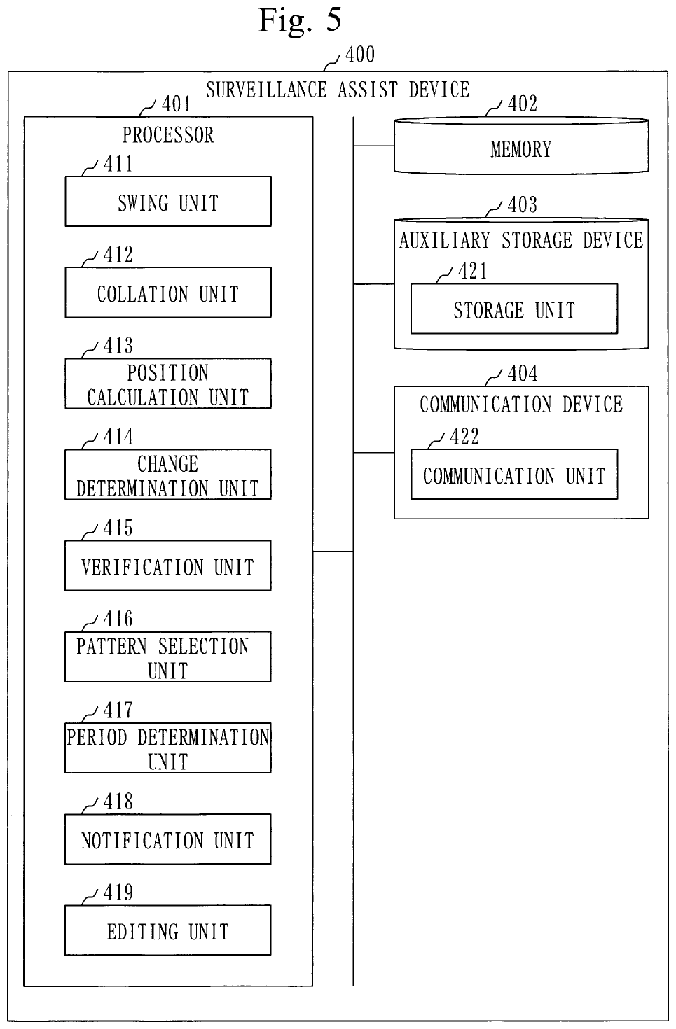

A configuration of the surveillance assist device 400 will be described with referring to FIG. 5.

The surveillance assist device 400 is a computer provided with hardware devices such as a processor 401, a memory 402, an auxiliary storage device 403, and a communication device 404. These hardware devices are connected to each other via signal lines.

The processor 401 is an IC which performs computation processing, and controls the other hardware devices. For example, the processor 401 is a CPU, a DSP, or a GPU.

The memory 402 is a volatile storage device. The memory 402 is also called a main storage device or a main memory. For example, the memory 402 is a RAM. Data stored in the memory 402 is saved in the auxiliary storage device 403 where necessary.

The auxiliary storage device 403 is a non-volatile storage device. For example, the auxiliary storage device 403 is a ROM, an HDD, or a flash memory. Data stored in the auxiliary storage device 403 is loaded to the memory 402 where necessary.

The communication device 404 is a receiver/transmitter. For example, the communication device 404 is a communication chip or an NIC.

The surveillance assist device 400 is provided with elements such as a swing unit 411, a collation unit 412, a position calculation unit 413, a change determination unit 414, a verification unit 415, a pattern selection unit 416, a period determination unit 417, a notification unit 418, and an editing unit 419. These elements are implemented by software.

A surveillance assist program is stored in the auxiliary storage device 403. The surveillance assist program is a program to cause the computer to function as the swing unit 411, the collation unit 412, the position calculation unit 413, the change determination unit 414, the verification unit 415, the pattern selection unit 416, the period determination unit 417, the notification unit 418, and the editing unit 419. The surveillance assist program is loaded to the memory 402 and executed by the processor 401.

Furthermore, an OS is stored in the auxiliary storage device 403. The OS is at least partly loaded to the memory 402 and executed by the processor 401.

That is, the processor 401 executes the surveillance assist program while executing the OS.

Data obtained by executing the surveillance assist program is stored in a storage device such as the memory 402, the auxiliary storage device 403, a register in the processor 401, or a cache memory in the processor 401.

The auxiliary storage device 403 functions as a storage unit 421. Alternatively, another storage device may function as the storage unit 421 in place of the auxiliary storage device 403 or along with the auxiliary storage device 403.

The communication device 404 functions as a communication unit 422.

The storage unit 421 and the communication unit 422 are controlled by the surveillance assist program. That is, the surveillance assist program also causes the computer to function as the storage unit 421 and the communication unit 422.

The surveillance assist device 400 may be provided with a plurality of processors that substitute for the processor 401. The plurality of processors share the role of the processor 401.

The surveillance assist program can be computer readably recorded (stored) in a non-volatile recording medium such as an optical disk or a flash memory.

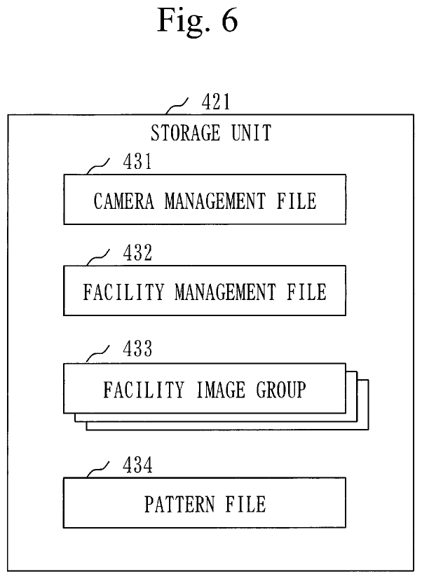

The storage unit 421 will be described with referring to FIG. 6.

The storage unit 421 mainly stores a camera management file 431, a facility management file 432, a facility image group 433, and a pattern file 434.

The camera management file 431 is a file that relates the camera 200 and the facility 112 photographed by the camera 200 to each other.

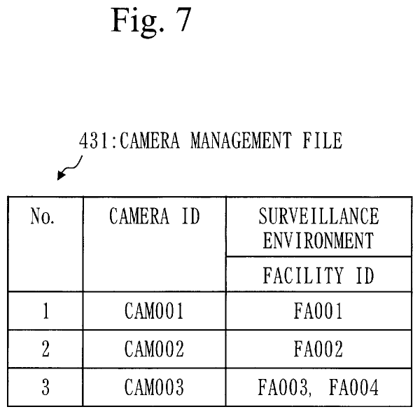

A configuration of the camera management file 431 will be described with referring to FIG. 7.

The camera management file 431 relates No., camera ID, and facility ID to each other, where ID signifies an identifier.

No. indicates a number.

Camera ID identifies the camera 200.

Facility ID identifies the facility 112.

The facility management file 432 is a file that relates the facility 112, operating hours, and the facility image group 433 to each other.

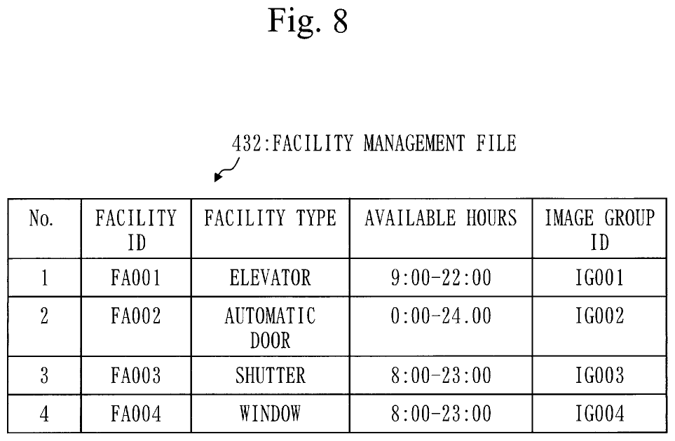

A configuration of the facility management file 432 will be described with referring to FIG. 8.

The facility management file 432 relates No., facility ID, facility type, available hours, and image group ID to each other.

Facility type is the type of the facility 112.

Available hours are hours determined in advance as hours during which the facility 112 can be used.

Image group ID identifies the facility image group 433.

The facility image group 433 contains a plurality of facility images.

The plurality of facility images are a plurality of images obtained by photographing the facility 112 in a plurality of directions.

The pattern file 434 is a file that indicates a plurality of swing patterns.

Each swing pattern indicates a content of swing control.

Swing control is control for causing the camera 200 to change its photographing range.

Specific examples of swing control are pan control, tilt control, and zoom control.

By pan control, the orientation of the camera 200 shifts right and left. Consequently, the photographing range of the camera 200 shifts right and left.

By tilt control, the orientation of the camera 200 shifts up and down. Consequently, the photographing range of the camera 200 shifts up and down.

Specific examples of zoom control are zoom-in control and zoom-out control.

By zoom-in control, the photographing range of the camera 200 narrows. By zoom-out control, the photographing range of the camera 200 widens.

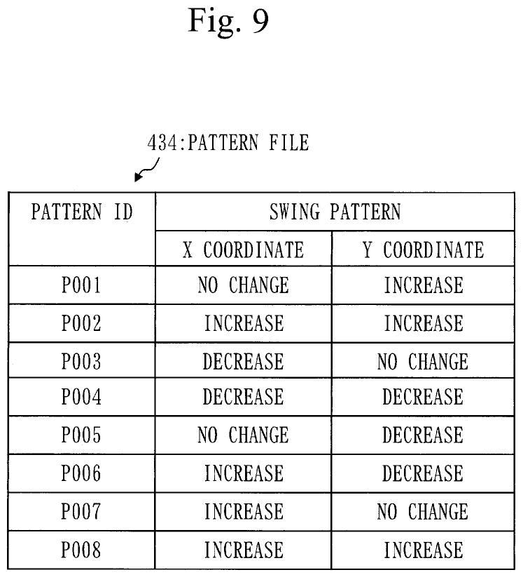

A configuration of the pattern file 434 will be described with referring to FIG. 9.

The pattern file 434 relates a pattern ID and a swing pattern to each other.

A pattern ID identifies a swing pattern.

A swing pattern specifies, for example, a direction in which the orientation of the camera 200 is to be shifted, by an x coordinate and a y coordinate.

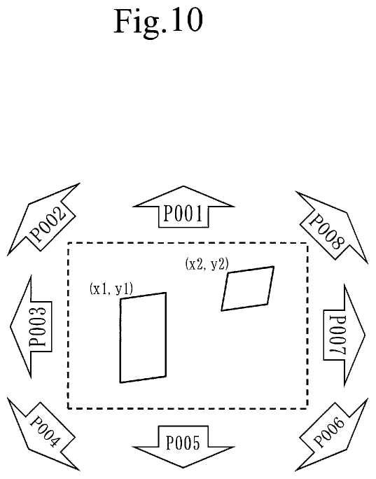

FIG. 10 illustrates an example of the swing patterns.

A broken-line frame indicates a photographing range.

Squares within the broken-line frame represent the facilities 112.

A lateral position is expressed by an x coordinate, and a longitudinal direction is expressed by a y coordinate.

With a swing pattern P001, the orientation of the camera 200 is shifted up. Consequently, the photographing range of the camera 200 shifts up. Hence, a portion showing the facility 112 shifts down.

With a swing pattern P002, the orientation of the camera 200 is shifted upper left. Consequently, the photographing range of the camera 200 shifts upper left. Hence, the portion showing the facility 112 shifts lower right.

With a swing pattern P003, the orientation of the camera 200 is shifted left. Consequently, the photographing range of the camera 200 shifts left. Hence, the portion showing the facility 112 shifts right.

With a swing pattern P004, the orientation of the camera 200 is shifted lower left. Consequently, the photographing range of the camera 200 shifts lower left. Hence, the portion showing the facility 112 shifts upper right.

With a swing pattern P005, the orientation of the camera 200 is shifted down. Consequently, the photographing range of the camera 200 shifts down. Hence, the portion showing the facility 112 shifts up.

With a swing pattern P006, the orientation of the camera 200 is shifted lower right. Consequently, the photographing range of the camera 200 shifts lower right. Hence, the portion showing the facility 112 shifts upper left.

With a swing pattern P007, the orientation of the camera 200 is shifted right. Consequently, the photographing range of the camera 200 shifts right. Hence, the portion showing the facility 112 shifts left.

With a swing pattern P008, the orientation of the camera 200 is shifted upper right. Consequently, the photographing range of the camera 200 shifts upper right. Hence, the portion showing the facility 112 shifts lower left.

***Description of Operation***

Operations of the surveillance assist device 400 correspond to a surveillance assist method. A procedure of the surveillance assist method corresponds to a procedure of a surveillance assist program.

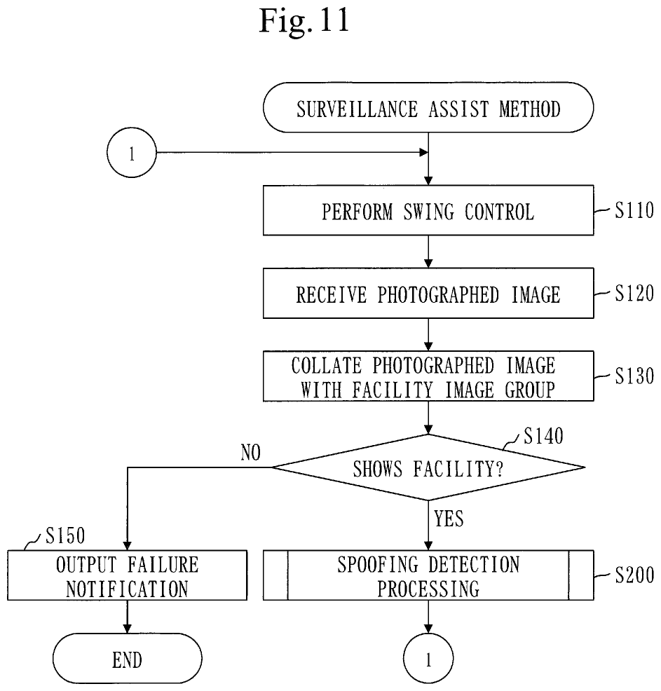

The surveillance assist method will be described with referring to FIG. 11.

In step S110, the swing unit 411 performs swing control according to a swing pattern and a swing period.

Specifically, the swing unit 411 performs swing control as follows.

First, the swing unit 411 generates a swing instruction indicating a swing pattern.

Subsequently, the swing unit 411 waits until the swing period lapses from an instruction time of the last time.

Then, the swing unit 411 transmits the swing instruction to the camera 200 via the recorder 300. That is, the communication unit 422 of the surveillance assist device 400 transmits the swing instruction to the recorder 300. The communication unit 313 of the recorder 300 receives the swing instruction and transmits the swing instruction to the camera 200.

In the camera 200, the communication unit 213 receives the swing instruction. The control unit 211 controls the image sensor 203 or the motor 205 to perform swing control.

In step S120, the communication unit 422 receives a photographic image. The storage unit 421 stores the received photographic image.

The photographic image is an image obtained by photographing with the camera 200.

The photographic image is transmitted to the surveillance assist device 400 as follows.

In the camera 200, the photographing unit 212 performs photographing, and the communication unit 213 transmits the photographic image to the recorder 300.

In the recorder 300, the communication unit 313 receives the photographic image, and the control unit 311 stores the photographic image in the memory 302. Furthermore, the control unit 311 transmits the photographic image to the surveillance assist device 400 via the communication unit 313.

The photographic image is communicated together with a camera ID that identifies the sender camera 200.

In step S130, the collation unit 412 collates the received photographic image with each facility image of the facility image group 433.

Collation is performed to detect from the photographic image a portion showing the facility 112. The portion showing the facility 112 will be called facility portion.

A procedure of step S130 is as follows.

First, the collation unit 412 acquires a facility ID related to the same camera ID as the camera ID of the photographic image, from the camera management file 431.

Subsequently, the collation unit 412 acquires an image group ID related to the same facility ID as the acquired facility ID, from the facility management file 432.

Subsequently, the collation unit 412 reads out the facility image group 433 identified by the acquired image group ID, from the storage unit 421.

Then, the collation unit 412 collates each facility image of the facility image group 433 with the photographic image.

Specifically, the collation unit 412 performs collation by a HOG detection scheme or a Canny filter. In the HOG detection scheme, a feature quantity based on brightness gradient is used. Note that HOG stands for Histogram of Oriented Gradients. The Canny filter performs edge detection.

The collation unit 412 may perform collation by another image analysis scheme.

Namely, collation can be performed with using a generally known technique.

In step S140, based on a collation result, the collation unit 412 determines whether the photographic image shows the facility 112.

If the photographic image shows the facility 112, the processing proceeds to step S200.

If the photographic image does not show the facility 112, the processing proceeds to step S150.

Step S200 is a step of performing spoofing detection processing.

The spoofing detection processing is processing for detecting video spoofing. That is, the spoofing detection processing is processing for determining whether the photographic image is a false image. The spoofing detection processing will be described later in detail.

After step S200, the processing proceeds to step S110.

In step S150, the notification unit 418 outputs a failure notification.

A failure notification is a notification for notifying occurrence of a failure. For example, a trouble of the camera 200 is notified by a failure notification.

Specifically, the notification unit 418 transmits the failure notification to a notification destination via the communication unit 422.

The notification destination is determined in advance. For example, the notification destination is a terminal in the surveillance room 114 or a terminal of an observer. Specific examples of the terminal include a personal computer, a portable terminal, and a tablet terminal.

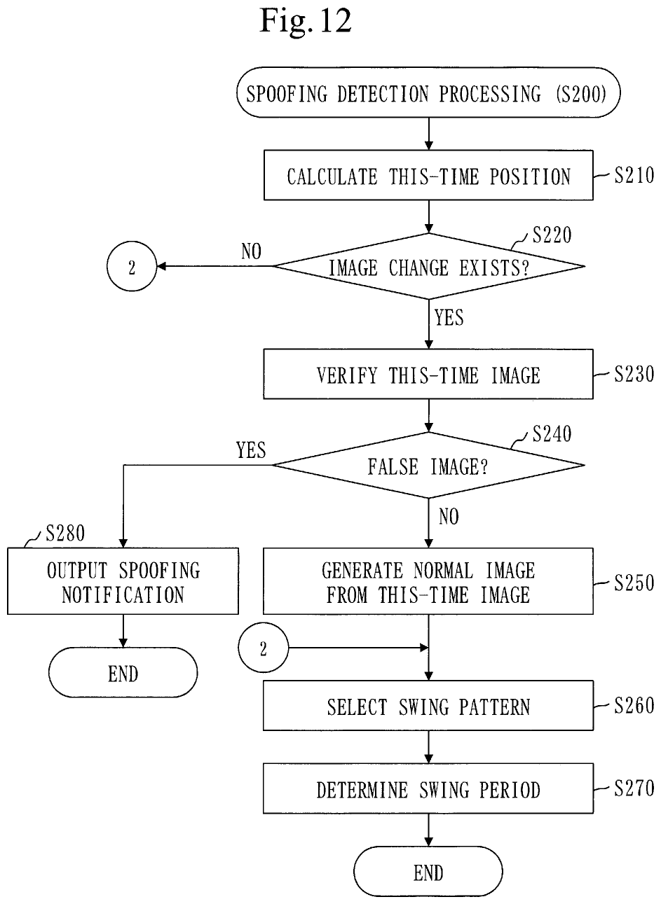

The spoofing detection processing (S200) will be described with referring to FIG. 12.

In the spoofing detection processing (S200), a photographic image of this time will be called this-time image, and the photographic image of the last time will be called last-time image.

In step S210, the position calculation unit 413 calculates a this-time position. The position calculation unit 413 stores the this-time position in the storage unit 421.

The this-time position is a representative position in the this-time image.

The representative position is a position representing a portion showing the facility 112.

Specifically, the position calculation unit 413 selects the this-time position from the facility portion detected in step S130 (see FIG. 11). For example, the position calculation unit 413 selects a coordinate value of the center of the facility portion.

The position calculation unit 413 has calculated the last-time position in step S210 of the last time. The last-time position has been stored in the storage unit 421.

The last-time position is a coordinate value representing a portion showing the facility 112 in the last-time image.

The this-time position and the last-time position are calculated for each facility 112.

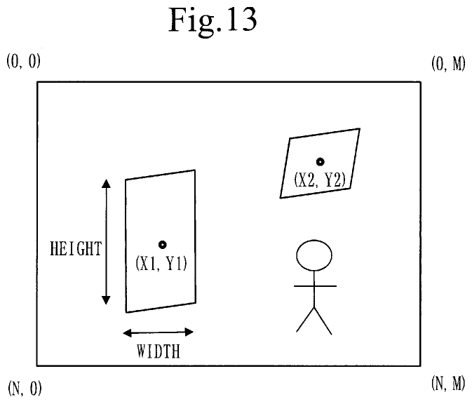

FIG. 13 illustrates an example of the photographic image.

Squares in the photographic image express facilities 112.

A coordinate value (X1, Y1) indicates a representative position of the first facility 112.

A coordinate value (X2, Y2) indicates a representative position of the second facility 112.

Back to FIG. 12, the description continues from step S220.

In step S220, the change determination unit 414 determines existence/nonexistence of an image change. That is, the change determination unit 414 determines whether or not the this-time image has changed from the last-time image.

Specifically, for each facility 112, the change determination unit 414 compares the this-time position with the last-time position.

If, for at least any one facility 112, the this-time position is different from the last-time position, the this-time image has changed from the last-time image.

The change determination unit 414 may calculate a motion vector using the last-time image and the this-time image and determine existence/nonexistence of an image change based on the motion vector.

A motion vector is standardized by a video coding method such as Moving Picture Experts Group (MPEG).

If an image change exists, the processing proceeds to step S230.

If an image change does not exist, the processing proceeds to step S260.

In step S230, the verification unit 415 verifies the this-time image.

Specifically, the verification unit 415 compares a range change quantity and a position change quantity.

A range change quantity is a quantity of change in the photographing range resulting from swing control.

A position change quantity is a quantity of change in the this-time position from the last-time position.

A change quantity is expressed by a vector. That is, a change quantity is expressed by a magnitude of the change and a direction of the change.

A procedure of step S230 will be described.

First, the verification unit 415 calculates the range change quantity based on a swing pattern of swing control.

Subsequently, the verification unit 415 calculates the position change quantity using the last-time position and the this-time position.

Then, the verification unit 415 compares the range change quantity and the position change quantity.

In step S240, the verification unit 415 determines whether the this-time image is a false image, based on a verification result.

If a magnitude of the position change quantity is the same as a magnitude of the range change quantity and a direction of the position change quantity is a direction opposite to a direction of the range change quantity, the this-time image is not a false image.

If the magnitude of the position change quantity is different from the magnitude of the range change quantity, the this-time image is a false image.

If the direction of the position change quantity is not opposite to the direction of the range change quantity, the this-time image is a false image.

If the this-time image is not a false image, the processing proceeds to step S250.

If the this-time image is a false image, the processing proceeds to step S280.

In step S250, the editing unit 419 generates a normal image from the this-time image.

A normal image corresponds to a photographic image obtained when swing control is not performed. That is, a normal image is an image obtained by shifting pixels of the this-time image by the position change quantity.

Specifically, the editing unit 419 transmits an editing instruction to the recorder 300 via the communication unit 422. The editing instruction indicates an image ID and a position change quantity.

In the recorder 300, the communication unit 313 receives the editing instruction. Then, the editing unit 312 selects the this-time image from among photographic images stored in the memory 302 or the auxiliary storage device 303. The editing unit 312 generates the normal image from the this-time image and updates the this-time image with the normal image.

The normal image is transmitted to the display 103 by the communication unit 313. The normal image is displayed on the display 103 as a surveillance image.

In step S260, the pattern selection unit 416 selects a swing pattern.

Specifically, the pattern selection unit 416 excludes the swing pattern selected from the pattern file 434 the last time, and selects a swing pattern randomly from among the remaining swing patterns.

For example, in the pattern file 434 of FIG. 9, assume that the swing pattern of the last time is swing pattern P001. In this case, the pattern selection unit 416 selects one swing pattern randomly from among the remaining swing patterns (P002 to P008).

In step S270, the period determination unit 417 determines a swing period based on the current clock time.

Specifically, the period determination unit 417 determines the swing period based on a relation between the available hours of the facility 112 and the current clock time.

A procedure of step S270 will be described.

First, the period determination unit 417 acquires facility ID related to the same camera ID as the camera ID of the this-time image, from the camera management file 431.

Subsequently, the period determination unit 417 acquires available hours related to the same facility ID as the acquired facility ID, from the facility management file 432.

Subsequently, the period determination unit 417 determines whether or not the current clock time is included in the available hours.

Then, the period determination unit 417 determines the swing period based on a determination result.

For example, a swing period for the available hours and a swing period for non-available hours are determined in advance.

If the current clock time is included in the available hours, the period determination unit 417 selects the swing period for the available hours.

If the current clock time is not included in the available hours, the period determination unit 417 selects the swing period for the non-available hours.

The swing pattern selected in step S260 and the swing period determined in step S270 are used in step S110 (see FIG. 11) of the next time.

In step S280, the notification unit 418 outputs a spoofing notification.

A spoofing notification is a notification for notifying video spoofing. That is, a spoofing notification is a notification for notifying that the this-time image is a false image.

Specifically, the notification unit 418 transmits the spoofing notification to a notification destination via the communication unit 422.

The notification destination is determined in advance. For example, the notification destination is a terminal in the surveillance room 114 or a terminal of the observer. Specific examples of the terminal include a personal computer, a portable terminal, and a tablet terminal.

***Effect of Embodiment 1***

Video spoofing can be detected.

Furthermore, a precision in detecting video spoofing is improved by execution of swing control and detection of an image change.

Since a signal generator in the prior art is not necessary, cost of the surveillance system 100 can be reduced. Also, it is possible to utilize an existing surveillance camera. Utilization of the existing surveillance camera leads to facility cost reduction.

Swing control (S110) and image verification (S230) provide an effect as a physical challenge and response. A change in a photographic image resulting from swing control is a change that is difficult to notice for a fraudulent person who conducts video spoofing.

In case of authentication by means of a password for communication connection between a camera and a record, there is a possibility that the password may be analyzed by a brute force attack or other schemes. If the analyzed password is perverted, it is highly likely that video spoofing will occur. Furthermore, there is a possibility that the observer does not notice video spoofing.

On the other hand, Embodiment 1 provides an effect of physical challenge and response and is accordingly excellent as a method of detecting video spoofing.

***Other Configurations***

The recorder 300 and the surveillance assist device 400 may be integrated.

That is, the functions of the surveillance assist device 400 may be mounted in the recorder 300, or the functions of the recorder 300 may be mounted in the surveillance assist device 400.

The camera 200 and the recorder 300 may perform encrypted communication with each other.

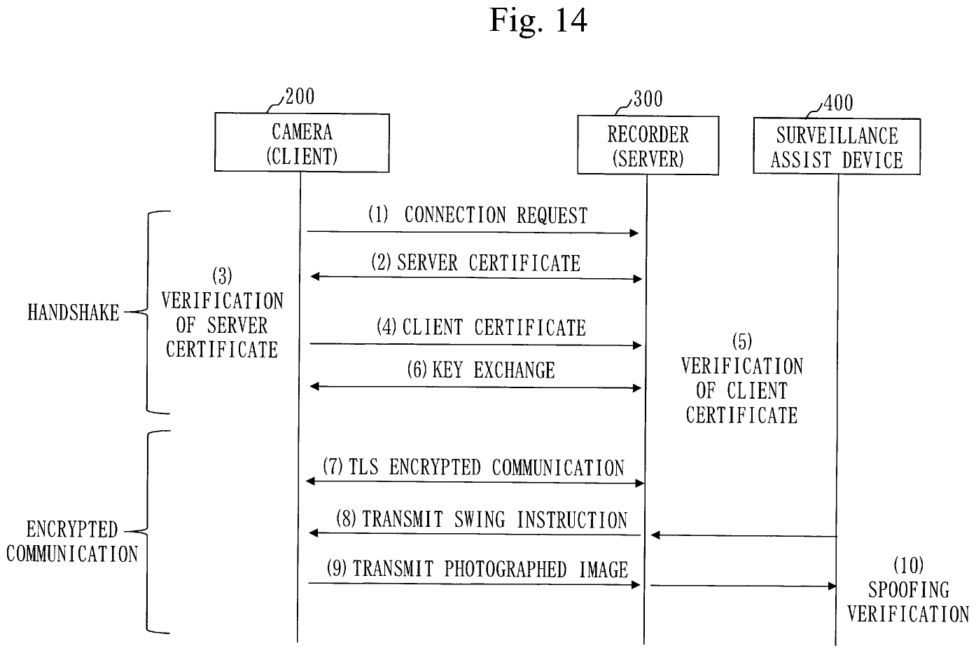

A procedure of encrypted communication in accordance with SSL/TLS will be described with referring to FIG. 14.

Note that SSL stands for Secure Sockets Layer, and that TLS stands for Transport Layer Security.

First, the camera 200 and the recorder 300 execute a handshake protocol.

By the handshake protocol, mutual authentication between the communication parties and secret key exchange are carried out.

In the handshake protocol, the camera 200 is the client and the recorder 300 is the server.

(1) The camera 200 requests connection of the recorder 300.

(2) The recorder 300 transmits a server certificate to the camera 200.

(3) The camera 200 verifies the server certificate.

(4) The camera 200 transmits a client certificate to the recorder 300.

(5) The recorder 300 verifies the client certificate.

(6) Common keys are exchanged between the camera 200 and the recorder 300.

After that, encrypted communication using the common keys is performed.

(7) TLS encrypted communication is performed between the camera 200 and the recorder 300.

(8) The recorder 300 transmits a swing instruction received from the surveillance assist device 400 to the camera 200.

(9) The camera 200 transmits a photographic image to the recorder 300. The photographic image is transmitted from the recorder 300 to the surveillance assist device 400.

(10) The surveillance assist device 400 performs spoofing verification.

As described above, Embodiment 1 can be combined with encrypted communication.

Even when security vulnerability is found in the SSL/TLS encrypted communication, that is, even when the encrypted communication becomes vulnerable temporarily, the surveillance assist device 400 can be utilized continuously. This enables protecting the surveillance system 100 in a multi-layered manner. Hence, the security of the surveillance system 100 can be further enhanced.

Swing control may be performed by a method other than a method of controlling the motor 205 of the camera 200. That is, swing control may be performed by a method other than physically driving the camera 200.

Specifically, swing control may be performed by software processing. For example, a tailoring process for the photographic image may be performed as swing control by the control unit 211 of the camera 200.

When the photographing range can be specified by a function command and the like of the camera 200, the photographing range of the photographic image can be changed by changing the position of the photographing range by several pixels. This enables spoofing detection without physically driving the camera 200. A further effect can be obtained that the target person 111 will not notice easily that he or she is under surveillance.

***Supplement to Embodiment***

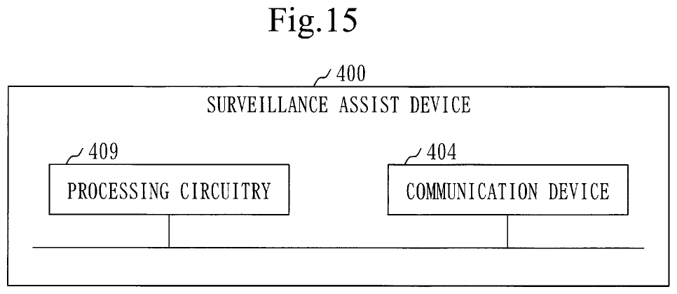

A hardware configuration of the surveillance assist device 400 will be described with referring to FIG. 15.

The surveillance assist device 400 is provided with processing circuitry 409.

The processing circuitry 409 is hardware that implements the swing unit 411, the collation unit 412, the position calculation unit 413, the change determination unit 414, the verification unit 415, the pattern selection unit 416, the period determination unit 417, the notification unit 418, the editing unit 419, and the storage unit 421.

The processing circuitry 409 may be dedicated hardware, or may be the processor 401 that executes the program stored in the memory 402.

When the processing circuitry 409 is dedicated hardware, the processing circuitry 409 is, for example, a single circuit, a composite circuit, a programmed processor, a parallel-programmed processor, an ASIC, or an FPGA; or a combination of them.

Note that ASIC stands for Application Specific Integrated Circuit, and that FPGA stands for Field Programmable Gate Array.

The surveillance assist device 400 may be provided with a plurality of processing circuitries that substitute for the processing circuitry 409. The plurality of processing circuitries share the role of the processing circuitry 409.

In the surveillance assist device 400, some of the functions may be implemented by dedicated hardware, and the remaining functions may be implemented by software or firmware.

In this manner, the processing circuitry 409 can be implemented by hardware, software, or firmware; or a combination of them.

The embodiment is an exemplification of a preferable mode and is not intended to limit the technical scope of the present invention. The embodiment may be practiced partly, or in combination with another mode. The procedures described with referring to the flowcharts and so on may be changed appropriately.

### REFERENCE SIGNS LIST

100: surveillance system; 101: first network; 101A: building network 101; 102: second network; 102A: indoor network; 103: display; 111: target person; 112: facility; 112A: elevator; 112B: automatic door; 112C: window; 112D: shutter; 113: building floor; 114: surveillance room; 200: camera; 201: processor; 202: memory; 203: image sensor; 204: communication device; 205: motor; 211: control unit; 212: photographing unit; 213: communication unit; 300: recorder; 301: processor; 302: memory; 303: auxiliary storage device; 304: communication device; 311: control unit; 312: editing unit; 313: communication unit; 400: surveillance assist device; 401: processor; 402: memory; 403: auxiliary storage device; 404: communication device; 409: processing circuitry; 411: swing unit; 412: collation unit; 413: position calculation unit; 414: change determination unit; 415: verification unit; 416: pattern selection unit; 417: period determination unit; 418: notification unit; 419: editing unit; 421: storage unit; 422: communication unit; 431: camera management file; 432: facility management file; 433: facility image group; 434: pattern file.

1-5. (canceled)

6. A surveillance assist device comprising:
processing circuitry
to calculate a last-time position representing a portion showing a stationary object in a last-time image obtained by a camera before swing control of causing the camera which photographs the stationary object to change a photographing range, and a this-time position representing a portion showing the stationary object in a this-time image obtained by the camera after the swing control;
to determine whether the this-time image is a false image based on a quantity of change in the photographing range resulting from the swing control and a quantity of change in the this-time position from the last-time position;
to exclude a swing pattern selected from a plurality of swing patterns last time, and to select a swing pattern randomly from among remaining swing patterns; and
to perform the swing control according to the selected swing pattern.

7. A surveillance assist device comprising:
processing circuitry
to calculate a last-time position representing a portion showing a stationary object in a last-time image obtained by a camera before swing control of causing the camera which photographs the stationary object to change a photographing range, and a this-time position representing a portion showing the stationary object in a this-time image obtained by the camera after the swing control;
to determine whether the this-time image is a false image based on a quantity of change in the photographing range resulting from the swing control and a quantity of change in the this-time position from the last-time position;
to determine a swing period with which the swing control is performed, based on a current clock time; and
to perform the swing control according to the swing period.

8. The surveillance assist device according to claim 7,
wherein the stationary object is a facility whose available hours have been determined, and
wherein the processing circuitry determines the swing period based on a relation between the available hours and the current clock time.
